(19) United States
(12) Patent Application Publication
(10) Pub. No.: US 2026/0200751 A1
(43) Pub. Date: Jul. 16, 2026

(54) SPHERICAL ALUMINA POWDER

(71) Applicant: Denka Company Limited, Tokyo (JP)

(72) Inventors: Junya NITTA, Chuo Tokyo (JP); Teruhiro AIKYO, Chuo Tokyo (JP)

(21) Appl. No.: 19/138,080

(22) PCT Filed: Dec. 15, 2023
(86) PCT No.: PCT/JP2023/045131

§ 371 Date: Jun. 11, 2025

(30) Foreign Application Priority Data
Dec. 16, 2022 (JP) 2022-201017

(51) Int. Cl. C01F 7/021

(52) U.S. Cl. CPC C01F 7/021; C01P 2004/32; C01P 2004/51; C01P 2004/61; C01P 2006/11; C01P 2006/20; C01P 2006/32

(57) ABSTRACT

A spherical alumina powder is provided in which, when a sphericity of the powder having a particle diameter of 5 μm or more and less than 10 μm is defined as S₁, a sphericity of the powder having a particle diameter of 10 μm or more and less than 20 μm is defined as S₂, a sphericity of the powder having a particle diameter of 20 μm or more and less than 30 μm is defined as S₃, a sphericity of the powder having a particle diameter of 30 μm or more and less than 45 μm is defined as S₄, and a sphericity of the powder having a particle diameter of 45 μm or more is defined as S₅ in a measurement using a wet-flow-type image analyzer, at least two or more of S₁, S₂, S₄, and S₅ are 0.85 or more, and S₃ is 0.84 or less.

### TECHNICAL FIELD

The present invention relates to a spherical alumina powder.

### BACKGROUND ART

Various developments have been made on spherical alumina powder so far. As this kind of technique, for example, a technique described in Patent Document 1 is known. Patent Document 1 describes a spherical alumina powder having an average particle diameter (D50) of 50 μm or less and a sphericity of 0.9 or more (claim 1 of Patent Document 1 or the like).

### RELATED DOCUMENT

### Patent Document

Patent Document 1: Japanese Unexamined Patent Publication No. 2015-193493

### SUMMARY OF THE INVENTION

### Technical Problem

However, as a result of studies conducted by the present inventors, it was found that there is room for improvement in the spherical alumina powder described in Patent Document 1 in terms of burr generation in a case of being used for a resin molding material.

### Solution to Problem

As a result of further studies, the present inventors have found that burrs generated during molding using a resin molding material including the spherical alumina powder can be suppressed by appropriately controlling the sphericity of the spherical alumina powder in each particle diameter class, and have completed the present invention.

According to one aspect of the present invention, the following spherical alumina powder is provided.

1. A spherical alumina powder in which, in a case where a sphericity of the spherical alumina powder having a particle diameter of 5 μm or more and less than 10 μm is defined as S₁, a sphericity of the spherical alumina powder having a particle diameter of 10 μm or more and less than 20 μm is defined as S₂, a sphericity of the spherical alumina powder having a particle diameter of 20 μm or more and less than 30 μm is defined as S₃, a sphericity of the spherical alumina powder having a particle diameter of 30 μm or more and less than 45 μm is defined as S₄, and a sphericity of the spherical alumina powder having a particle diameter of 45 μm or more is defined as S₅ in a measurement using a wet flow type image analyzer, at least two or more of S₁, S₂, S₄, and S₅ are 0.85 or more, and

S₃ is 0.84 or less.

2. The spherical alumina powder according to 1.,
in which in a case where an average sphericity obtained from five values of S₁, S₂, S₃, S₄, and S₅ (excluding a value of 0) is defined as S_{AVE}, S_{AVE} is 0.80 or more.

3. The spherical alumina powder according to 1, or 2.,
in which a loose bulk density measured by the following procedure is 1.10 g/cm3 or more and 1.50 g/cm3 or less,

### (Procedure)

the spherical alumina powder is allowed to free-fall from a height of 25 cm to be injected into a 100 cm³ cup for measurement in an injection amount of 5 to 10 g for 1 minute, and the injection is continued until the spherical alumina powder overflows from the cup to prepare a heaped cup;
next, after rubbing off the powder overflowing from an upper surface of the heaped cup without tapping, a mass (g) of the spherical alumina powder filled in the cup is measured to calculate the loose bulk density (g/cm³); and
on the other hand, after tapping the heaped cup in a vertical direction under a condition of 180 times (stroke length: 2 cm, 1 sec/time) and rubbing off the powder overflowing from the upper surface of the cup, a mass (g) of the spherical alumina powder filled in the cup is measured to calculate a tight bulk density (g/cm³).

4. The spherical alumina powder according to any one of 1. to 3.,
in which in a case where the loose bulk density measured by the procedure is denoted as A and the tight bulk density measured by the procedure is denoted as P, a compression degree obtained based on ((P−A)/P)×100 is 35% or more and 55% or less.

5. The spherical alumina powder according to any one of 1. to 4.,
in which in a volume frequency particle size distribution measured by a laser diffraction scattering method under wet conditions, in a case where a particle diameter corresponding to a cumulative value of 25% is defined as D₂₅ and a particle diameter corresponding to a cumulative value of 97% is defined as D₉₇, D₉₇/D₂₅ is 8.0 or more and 30.0 or less.

6. The spherical alumina powder according to any one of 1. to 5.,
in which in a volume frequency particle size distribution measured by a laser diffraction scattering method under wet conditions, in a case where a particle diameter corresponding to a cumulative value of 50% is defined as D₅₀ and a particle diameter corresponding to a cumulative value of 97% is defined as D₉₇, D₉₇/D₅₀ is 5.0 or more and 20.0 or less.

### Advantageous Effects of Invention

According to the present invention, there is provided a spherical alumina powder having excellent burr suppression in a case of being used in a resin molding material.

### BRIEF DESCRIPTION OF THE DRAWINGS

FIG. 1 A schematic cross-sectional view showing a configuration of a thermal spraying device.

### DESCRIPTION OF EMBODIMENTS

Hereinafter, an embodiment of the present invention will be described using the drawings. It is noted that in all the drawings, the same constitutional elements are denoted as the same reference numerals and explanations thereof will not be repeated, as appropriate. In addition, the figures are schematic views and do not correspond to the actual dimensional ratios.

The spherical alumina powder according to the present embodiment will be described.

In the spherical alumina powder of the present embodiment, in a case where a sphericity of a particle diameter of 5 μm or more and less than 10 μm is defined as S₁, a sphericity of a particle diameter of 10 μm or more and less than 20 μm is defined as S₂, a sphericity of a particle diameter of 20 μm or more and less than 30 μm is defined as S₃, a sphericity of a particle diameter of 30 μm or more and less than 45 μm is defined as S₄, and a sphericity of a particle diameter of 45 μm or more is defined as S₅ in a measurement using a wet flow type image analyzer, at least two or more of S₁, S₂, S₄, and S₅ are 0.85 or more, and S₃ is 0.84 or less.

Although the detailed mechanism is not clear, it is considered that, by controlling the sphericity for each of the above-described particle diameter classes, appropriate viscoelastic characteristics can be realized in a resin molding material in a case of being blended with a resin (resin composition), and thus burr generation during molding can be suppressed.

Among S₁, S₂, S₃, S₄, and S₅, those satisfying 0.85 or more may be at least two or more, preferably three or more, and more preferably four or more. As a result, burr generation during molding of the resin molding material containing the spherical alumina powder can be suppressed.

In addition, the upper limit of S₃ may satisfy 0.84 or less, and is preferably 0.83 or less and more preferably 0.82 or less. As a result, burr generation during molding of the resin molding material can be suppressed.

The lower limit of S₃ is not particularly limited, but may be 0.60 or more or 0.70 or more.

An average sphericity obtained from five values (where a value of 0 is excluded) of S₁, S₂, S₃, S₄, and S₅ is represented by S_{AVE}.

The lower limit of S_{AVE} may be, for example, 0.80 or more, preferably 0.82 or more, and more preferably 0.84 or more. As a result, the fluidity of the resin molding material can be improved. The upper limit of S_{AVE} may be, for example, 0.99 or less.

In the present embodiment, for example, by appropriately selecting the raw material components of the spherical alumina powder, the method of producing the spherical alumina powder, and the like, it is possible to control the sphericity in each particle diameter class of S₁, Ω, S₃, S₄, and S₅, or S_{AVE}. Among these, for example, appropriately controlling melting flame conditions such as a raw material supply amount, a raw material particle diameter, a flame temperature, a combustible gas, a combustion-supporting gas, and a dispersion gas, heating a carrier gas of a raw material (element (iv) below), and using alumina raw material powders having different particle diameters in combination are exemplified as elements for setting the sphericity in each particle diameter class of S₁, S₂, S₃, S₄, and S₅, or S_{AVE} to a desired numerical value range.

For example, in order to control the sphericity in each particle diameter class, (i) the sphericity increases in a case where the raw material supply amount is reduced, and the sphericity decreases in a case where the raw material supply amount is increased, (ii) in a case where the raw material is supplied to the flame, the sphericity increases by increasing the dispersibility of the raw material and reducing adhesion between the raw material, to obtain a target particle size, (iii) the sphericity increases as the particle diameters of the plurality of raw materials are closer to the average particle diameter, and the sphericity decreases as the particle diameters deviate from the average particle diameter, (iv) the sphericity increases as the flame temperature is higher, and the sphericity decreases as the flame temperature is lower, (v) the sphericity increases as the temperature of the combustible gas is higher, and the sphericity decreases as the temperature of the combustible gas is lower, (vi) the sphericity increases as the theoretical ratio of the combustion-supporting gas is closer to the theoretical ratio, and the sphericity decreases as the theoretical ratio deviates from the theoretical ratio, and (vii) the sphericity increases by appropriately introducing the dispersion gas to reduce the adhesion.

In a case where a loose bulk density measured by the following procedure is denoted as A and a tight bulk density measured by the following procedure is denoted as P, the spherical alumina powder may be configured such that a compression degree obtained based on ((P−A)/P)×100 is, for example, 35% or more and 55% or less.

The loose bulk density, the tight bulk density, and the compression degree can be measured according to the following procedure under the conditions of a room temperature of 25° C. and a humidity of 55%.

The spherical alumina powder is allowed to free-fall from a height of 25 cm to be injected into a 100 cm³ cup for measurement in an injection amount of 5 to 10 g for 1 minute, and the injection is continued until the spherical alumina powder overflows from the cup to prepare a heaped cup.

Next, after rubbing off the powder overflowing from an upper surface of the heaped cup without tapping, a mass (g) of the spherical alumina powder filled in the cup is measured to calculate the loose bulk density (g/cm³).

On the other hand, after tapping the heaped cup in a vertical direction under a condition of 180 times (stroke length: 2 cm, 1 sec/time) and rubbing off the powder overflowing from the upper surface of the cup, a mass (g) of the spherical alumina powder filled in the cup is measured to calculate a tight bulk density (g/cm³).

$$The compression degree ( \% ) is calculated based on ( ( P - A ) / P ) \times 100 using the loose bulk density ( A ) and the tight bulk density ( P ) obtained by the above procedure .$$

The lower limit of the compression degree may be, for example, 35% or more, preferably 38% or more, and more preferably 40% or more. As a result, the handleability of the spherical alumina powder can be improved.

The upper limit of the compression degree may be, for example, 55% or less, preferably 53% or less, and more preferably 50% or less. As a result, the mixing properties between the resin and the spherical alumina powder can be improved.

The spherical alumina powder may be configured such that the loose bulk density (A) is 1.10 g/cm³ or more and 1.50 g/cm³ or less.

The lower limit of the loose bulk density (A) may be, for example, 1.10 cm³/g or more, preferably 1.15 cm³/g or more, and more preferably 1.20 cm³/g or more. As a result, the compactness is improved, and there is a possibility of improving the strength of the molded body of the resin molding material.

The upper limit of the loose bulk density (A) may be, for example, 1.50 cm³/g or less, preferably 1.45 cm³/g or less, and more preferably 1.40 cm³/g or less. As a result, the mixing properties between the resin and the spherical alumina powder can be improved.

A volume frequency particle size distribution of the spherical alumina powder is measured by a laser diffraction scattering method under wet conditions, and in the obtained volume frequency particle size distribution, a particle diameter corresponding to a cumulative value of 25% is defined as D₂₅, a particle diameter corresponding to a cumulative value of 50% is defined as D₅₀, and a particle diameter corresponding to a cumulative value of 97% is defined as D₉₇.

The lower limit of D₉₇/D₂₅ may be, for example, 8.0 or more, preferably 9.0 or more, and more preferably 10.0 or more. As a result, the particle size distribution has a constant width, and fluidity and moldability can be improved.

The upper limit of D₉₇/D₂₅ may be, for example, 30.0 or less, preferably 20.0 or less, and more preferably 18.0 or less. As a result, the particle size of the coarse particles is sharpened, and the molding defect of the molded body due to the coarse particles can be suppressed.

The lower limit of D₉₇/D₅₀ may be, for example, 5.0 or more, preferably 5.5 or more, and more preferably 6.0 or more. As a result, the particle size distribution has a constant width, and fluidity and moldability can be improved.

The upper limit of D₉₇/D₅₀ may be, for example, 20.0 or less, preferably 10.0 or less, and more preferably 8.0 or less. As a result, the particle size of the coarse particles is sharpened, and the molding defect of the molded body due to the coarse particles can be suppressed.

The lower limit of D₉₀ may be, for example, 20.0 μm or more, preferably 25.0 μm or more, and more preferably 30.0 μm or more.

The upper limit of D₉₀ may be, for example, 80.0 μm or less, preferably 70.0 μm or less, and more preferably 60.0 μm or less.

The particle size distribution of the spherical alumina powder includes values based on particle size measurement using a laser diffraction scattering method, and can be measured using a particle size distribution measuring machine, for example, “MODEL LS-13230” (manufactured by Beckman Coulter, Inc.). During the measurement, water is used as a solvent, and as a pre-treatment, a dispersion treatment is performed by applying an output of 200 W for 1 minute using a homogenizer. In addition, a polarization intensity differential scattering (PIDS) concentration is prepared to be 45 to 55%. 1.33 is used as a refractive index of water, and a refractive index of a material of the powder is considered as a refractive index of the powder. For example, amorphous silica is measured assuming that the refractive index is 1.50, and alumina is measured assuming that the refractive index is 1.68.

A method of producing the spherical alumina powder of the present embodiment will be described.

The spherical alumina powder may be produced, for example, by supplying an alumina raw material powder into a high-temperature flame formed by a combustion reaction of a combustible gas and a combustion-supporting gas, and melting and spheroidizing the alumina raw material powder at a melting point or higher. The particles obtained by such a flame melting method are referred to as molten spherical particles. The obtained molten spherical particles may be further subjected to a classification and sieving treatment as necessary. As the alumina raw material powder, a plurality of raw material powders having different particle diameters are used.

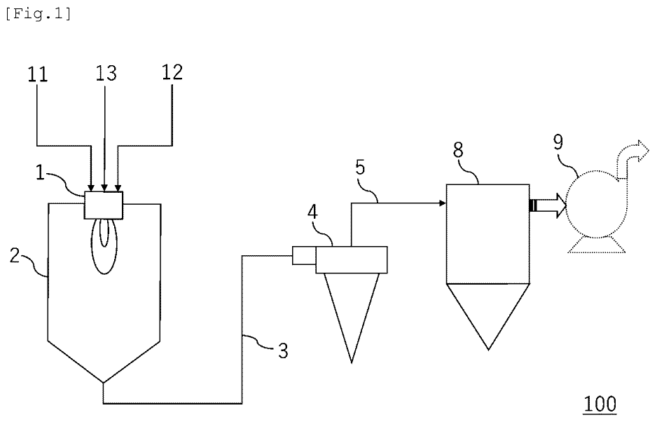

FIG. 1 shows an example of a schematic diagram of a thermal spraying device used for manufacturing the molten spherical particle.

A thermal spraying device 100 of FIG. 1 is configured by a melting furnace 2 provided in a burner 1, a cyclone 4 for classifying molten spherical particles produced from high-temperature exhaust gas of the flame by suction of a blower 9, and a bag filter 8 for recovering fine powder that cannot be collected by the cyclone 4.

The melting furnace 2 is configured with a vertical furnace body but is not limited thereto. The melting furnace 2 may be a so-called horizontal furnace or an inclined furnace that is a horizontal type and blasts a flame in a horizontal direction.

The high-temperature exhaust gas is cooled by pipes 3 and 5 including a water-cooling jacket.

A suction gas amount control valve and a gas exhaust port (not shown) may be connected to the blower 9.

A collected powder extraction device (not shown) may be connected to lower portions of the melting furnace 2, the cyclone 4, and the bag filter 8.

The classification can be performed using a well-known device such as a gravity-settling chamber, a cyclone, or a classifier having a rotary blade. This classification operation may be incorporated into a transport step of a melted and spheroidized product, or may be performed in another line after collecting the powder in a batchwise manner.

As the combustible gas, for example, one kind or two or more kinds such as acetylene, propane, or butane may be used. Propane, butane, or a mixed gas thereof having a relatively small amount of heat generation is preferable.

As the combustion-supporting gas, for example, gas including oxygen may be used. In general, the use of pure oxygen having 99 mass % or more is inexpensive and most preferable. In order to reduce the amount of heat generation from the gas, inert gas such as air or argon can also be mixed with the combustion-supporting gas.

As alumina raw material powder that is raw material powder, for example, alumina powder having an average particle diameter of 3 to 70 μm may be used. The supply of aluminum hydroxide powder into a high-temperature flame may be performed through a dry process or a wet process in the form of a slurry using water or the like.

A resin composition obtained by blending the spherical alumina powder according to the present invention can be suitably used as a resin molding material.

The resin composition contains a resin, a known resin additive, and the like, in addition to the spherical alumina powder according to the present invention.

The spherical alumina powder may be used alone or may be used by being mixed with other fillers in the resin composition. The resin composition may contain 10 to 99 mass % of the spherical alumina powder, or may contain 10 to 99 mass % of a mixed inorganic powder containing the spherical alumina powder and other fillers. In addition, the content of the other filler in the mixed inorganic powder may be, for example, 1 to 20 mass % or 3 to 15 mass % with respect to 100 mass % of the spherical alumina powder.

In the present specification, “to” represents that an upper limit value and a lower limit value are included unless specified otherwise.

Examples of the other fillers include crystalline silica, fused silica, titania, silicon nitride, aluminum nitride, silicon carbide, talc, and calcium carbonate.

As the average particle diameter of the other fillers, for example, a filler having an average particle diameter of about 5 to 100 μm may be used, and the particle size configuration and shape thereof are not particularly limited.

Examples of the above-described resin include an epoxy resin, a silicone resin, a phenol resin, a melamine resin, a urea resin, an unsaturated polyester, a fluororesin, a polyamide such as polyimide, polyamideimide, or polyetherimide, a polyester such as polybutylene terephthalate or polyethylene terephthalate, polyphenylene sulfide, wholly aromatic polyester, polysulfone, a liquid crystal polymer, polyethersulfone, polycarbonate, a maleimide-modified resin, an ABS resin, an acrylonitrile-acrylic rubber-styrene (AAS) resin, and an acrylonitrile-ethylene-propylene-diene rubber-styrene (AES) resin. These resins may be used alone or may be used in combination of two or more kinds.

The resin composition can be manufactured, for example, by blending raw material components at a predetermined amount ratio using a blender, a Henschel mixer, or the like, kneading the blended product using a heating roll, a kneader, a single-screw or twin-screw kneader, or the like, and cooling and crushing the kneaded product.

Hereinabove, the embodiment of the present invention has been described. However, the embodiment is merely an example of the present invention, and various configurations other than the above-described configurations can be adopted. In addition, the present invention is not limited to the above-described embodiment, and modifications, improvements, and the like within a range where the object of the present invention can be achieved are included in the present invention.

### EXAMPLES

Hereinafter, the present invention will be described in detail with reference to Examples. However, the present invention is not limited to the description of these Examples.

### <Production of Spherical Alumina Powder>

A spherical alumina powder was produced using the thermal spraying device 100 shown in FIG. 1.

The thermal spraying device 100 shown in FIG. 1 includes the melting furnace 2, the burner 1 that is provided in an upper portion of the melting furnace 2, and a collection line that is directly connected to a lower portion of the melting furnace 2 and consists of the cyclone 4 and the bag filter 8.

The burner 1 had a double pipe structure capable of forming an inner flame and an outer flame, was provided on the top portion of the melting furnace 2, and was connected to each of a combustible gas pipe 11, a combustion-supporting gas supply pipe 12, and a raw material supply pipe 13.

In the melting furnace 2, the raw material powder was supplied into a high-temperature flame by the raw material supply pipe 13 and was melted such that spheroidized molten spherical particles were able to be formed. The molten spherical particles having passed through the melting furnace 2 were sucked by the blower 9 together with combustion exhaust gas, were moved into the pipes 3 and 5 by the air, and were classified and collected by the cyclone 4 or the bag filter 8.

### Example 1

Using the above-described thermal spraying device 100, LPG as the combustible gas was supplied from the combustible gas pipe 11, oxygen as the combustion-supporting gas was supplied from the combustion-supporting gas supply pipe 12, and a high-temperature flame was formed by combustion of LPG and oxygen in the burner 1.

Secondary air was supplied to the cyclone 4 by a rotary valve (not shown) provided in the pipe 3. As the secondary air, air in the atmosphere was used. In addition, the opening and closing degree of a lower valve (lower aperture) in the cyclone 4 was set to 100%.

As the raw material powder, a plurality of alumina powders having a maximum value in a range of an average particle diameter (D₅₀) of 2 to 45 μm were used. The supply amounts were 15 Nm³/hr for the carrier gas of the raw material heated to 500° C., 5 Nm³/hr for the combustible gas of the burner, and 10 Nm³/hr for the combustion-supporting gas. The molten spherical particles collected by the bag filter 8 were recovered as the spherical alumina powder.

### Examples 2 to 4

Spherical alumina powder was recovered in the same manner as in Example 1, except that in the classification treatment in the production of the spherical alumina powder, the lower aperture was changed to 20%, 25%, and 35%, respectively.

### Comparative Example 1

Spherical alumina powder was recovered in the same manner as in Example 1, except that in the production of the spherical alumina powder, the burner was set to a combustible gas of 7.5 Nm³/hr.

### <Sphericity>

The sphericity of the obtained spherical alumina powder was determined as follows under the conditions of a room temperature of 25° C. and a humidity of 70%.

In the obtained spherical alumina powder, using a wet flow type image analyzer (manufactured by Sysmex Corporation, FPIA-3000), a sphericity(S) of a particle diameter of 5 μm or more and less than 10 μm, a sphericity (S₂) of a particle diameter of 10 μm or more and less than 20 μm, a sphericity (S₃) of a particle diameter of 20 μm or more and less than 30 μm, a sphericity (S₄) of a particle diameter of 30 μm or more and less than 45 μm, and a sphericity (S₅) of a particle diameter of 45 μm or more were measured.

### [Measurement Procedure]

A measurement sample used in the wet flow type image analyzer was adjusted as follows.

0.05 g of a sample of a spherical alumina powder was weighed in a 20 ml glass beaker container, and 10 ml of a 25 mass % of a propylene glycol aqueous solution was added thereto, and then the mixture was dispersed for 3 minutes with an ultrasonic disperser (ASU-10M manufactured by AS ONE Corporation). The total amount of the solution was put into FPIA-3000 and was measured in an LPF mode/quantitative count system (total number of counts: 100, number of repetitions of measurement: 1).

Using the above-described wet flow type image analyzer, a perimeter of one particle projection image and a perimeter of a circle corresponding to the area of the particle projection image were analyzed, and a circularity was obtained from the following expression.

$$Circularity = ( Perimeter of Particle Projection Image ) / ( Perimeter of Circle Corresponding to Area of Particle Projection Image )$$

The sphericity and the circularity were average values of the particles in the range of each of the particle diameter classes.

The sphericity was a value obtained by squaring the circularity of each of the particle diameter classes.

In addition, an average sphericity (S_{AVE}) was calculated from five values of S₁, S₂, S₃, S₄, and S₅ (where a value of 0 is excluded).

### <Loose Bulk Density, Tight Bulk Density>

In the obtained spherical alumina powder, a loose bulk density and a tight bulk density were measured using a powder tester (PT-E type, manufactured by Hosokawa Micron Group) under conditions of a room temperature of 25° C. and a humidity of 55%.

The specific procedure was as follows.

The spherical alumina powder as a measurement sample was allowed to free-fall from a height of 25 cm to be injected into a 100 cm³ cup for measurement in an injection amount of 5 to 10 g for 1 minute, and the injection was continued until the spherical alumina powder overflows from the cup to prepare a heaped cup.

Next, after rubbing off the powder overflowing from an upper surface of the heaped cup without tapping, a mass (g) of the spherical alumina powder filled in the cup was measured to calculate a loose bulk density (g/cm³).

On the other hand, after tapping the heaped cup in a vertical direction under a condition of 180 times (stroke length: 2 cm, 1 sec/time) and rubbing off the powder overflowing from the upper surface of the cup, a mass (g) of the spherical alumina powder filled in the cup was measured to calculate the tight bulk density (g/cm³).

When the loose bulk density and the tight bulk density obtained in the above-described procedure were represented by A and P, respectively, the compression degree (%) was obtained based on the expression: “((P−A)/P)×100”.

### <Particle Size Distribution>

Regarding the obtained spherical alumina powder, a volume frequency particle size distribution was obtained with a laser diffraction scattering method under wet conditions using a particle size distribution measuring apparatus (LS-13230, manufactured by Beckman Coulter, Inc.). Water was used as a solvent, and as a pre-treatment, a dispersion treatment was performed by applying an output of 200 W for 1 minute using a homogenizer. In addition, a polarization intensity differential scattering (PIDS) concentration was prepared to be 45 to 55% for the measurement.

Based on the obtained volume frequency particle size distribution, a particle diameter Dx corresponding to a cumulative value of X % was calculated.

TABLE 1

| | | | | | | | Comparative |
|---|---|---|---|---|---|---|---|
| Alumina powder | | Unit | Example 1 | Example 2 | Example 3 | Example 4 | Example 1 |
| Sphericity | 5~10 μm (S₁) | | 0.86 | 0.89 | 0.87 | 0.90 | 0.86 |
| | 10~20 μm (S₂) | — | 0.86 | 0.84 | 0.84 | 0.86 | 0.90 |
| | 20~30 μm (S₃) | — | 0.78 | 0.78 | 0.81 | 0.81 | 0.86 |
| | 30~45 μm (S₄) | — | 0.89 | 0.88 | 0.81 | 0.83 | 0.91 |
| | ≥45 μm (S₅) | — | 0.97 | 0.97 | 0.90 | 0.89 | 0.94 |
| | S_{AVE} | | 0.87 | 0.87 | 0.85 | 0.86 | 0.89 |
| Powder | Loose bulk | g/cm³ | 1.28 | 1.39 | 1.37 | 1.21 | — |
| characteristics | density (A) | | | | | | |
| | Tight bulk | g/cm³ | 2.31 | 2.43 | 2.38 | 2.29 | — |
| | density (P) | | | | | | |
| | Compression | | 45 | 43 | 42 | 47 | — |
| | degree | | | | | | |
| Particle size | D₂₅ | μm | 3.2 | 3.7 | 3.1 | 4.8 | 3.8 |
| distribution | D₅₀ | μm | 7.3 | 7.0 | 5.9 | 7.9 | 6.0 |
| | D₉₇ | μm | 50.2 | 55.1 | 40.0 | 50.2 | 22 |
| | D₉₇/D₅₀ | | 6.8 | 7.8 | 6.8 | 6.3 | 3.6 |
| | D₉₇/D₂₅ | | 15.9 | 14.7 | 12.8 | 10.4 | 5.7 |

| | | | | | |
|---|---|---|---|---|---|
| Burr suppression | Good | Good | Good | Good | Bad |
| Fluidity | Good | Good | Good | Good | — |
| Thermal conductivity (W/m · K) | 4.2 | 4.3 | 4.3 | 4.4 | 3.7 |

The obtained spherical alumina powder of each of Examples and Comparative Examples was evaluated as follows.

The results are listed in Table 1. In Table 1, “-” means not measured.

### <Burr Suppression>

90.1 parts by mass of the obtained spherical alumina powder, 4.8 parts by mass of a biphenylene aralkyl phenol type epoxy resin (manufactured by Nippon Kayaku Co., Ltd., trade name: NC-3000, epoxy equivalent: 275, softening point: 56° C.), 3.7 parts by mass of a phenol resin (phenol aralkyl resin, MEHC-7800S manufactured by MEIWA PLASTICS CO., LTD.), 0.19 parts by mass of triphenylphosphine (manufactured by Hokko Chemical Industry Co., Ltd., TPP), and 0.35 parts by mass of N-phenyl-3-aminopropyltrimethoxysilane (manufactured by Shin-Etsu Chemical Co., Ltd., KBM-573) were mixed using a Henschel mixer (“FM-20C/I” manufactured by Nippon Coke & Chemicals Co., Ltd.) under the conditions of room temperature and a rotation speed of 2000 rpm, and the obtained mixture was heated and kneaded with a co-rotating twin-screw extruder (screw diameter D=25 mm, L/D=10.2, paddle rotation speed: 50 to 120 rpm, discharge amount: 3.0 kg/Hr, temperature of kneaded product: 98° C. to 100° C.) to obtain a resin composition.

When the obtained resin composition was molded using a mold for burr measurement having slits of 2 μm, 5 μm, 10 μm, or 30 μm, at a molding temperature of 175° C. and a molding pressure of 7.4 MPa, the resin cast into the slit was measured using a caliper, and values measured at the slits were averaged to obtain a burr length (μm).

When the burr length was 2 mm or less, it was evaluated that the burr generation during molding can be suppressed (Good), and when the burr length was more than 2 mm, it was evaluated that burrs may occur during molding (Bad).

### <Fluidity>

The obtained resin composition was used and was tested using a spiral flow mold according to Epoxy Molding Material Institute; Society of Plastic Industry (EMMI-1-66). A mold temperature was 175° C., a molding pressure was 7.4 MPa, and a pressure holding time was 90 seconds.

A spiral flow of 150 cm or more was evaluated as Good, and a spiral flow of less than 150 cm was evaluated as Bad.

### <Thermal Conductivity>

Using the resin composition obtained above, the resin composition was poured into a mold having a disk-shaped hole having a diameter of 28 mm and a thickness of 3 mm, and molded at 150° C. x 20 minutes after degassing. For the obtained resin composition, a thermal conductivity (W/m·K) was measured by a steady-state method in accordance with ASTM D₅₄₇₀ using a thermal conductivity measuring device (resin material thermal resistance measuring device “TRM-046RHHT” (trade name) manufactured by Hitachi Technology & Services, Ltd.). The resin composition was processed into a width of 10 mm×10 mm, and the measurement was carried out while applying a load of 2 N.

The spherical alumina powders of Examples 1 to 4 showed results that burr generation during molding of the resin composition could be suppressed, as compared with Comparative Example 1. In addition, the spherical alumina powders of Examples 1 to 4 had excellent fluidity in a case of being used for a resin molding material, and showed results of improving the thermally conductive properties of the resin molding material.

The present application claims priority based on Japanese Patent Application No. 2022-201017 filed on Dec. 16, 2022, the entire content of which is incorporated herein by reference.

### REFERENCE SIGNS LIST

1 burner
2 melting furnace
3 pipe
4 cyclone
5 pipe
8 bag filter
9 blower
11 combustible gas pipe
12 combustion-supporting gas supply pipe
13 raw material supply pipe
100 thermal spraying device

1. A spherical alumina powder in which, in a case where a sphericity of the spherical alumina powder having a particle diameter of 5 μm or more and less than 10 μm is defined as S₁, a sphericity of the spherical alumina powder having a particle diameter of 10 μm or more and less than 20 μm is defined as S₂, a sphericity of the spherical alumina powder having a particle diameter of 20 μm or more and less than 30 μm is defined as S₃, a sphericity of the spherical alumina powder having a particle diameter of 30 μm or more and less than 45 μm is defined as S₄, and a sphericity of the spherical alumina powder having a particle diameter of 45 μm or more is defined as S₅ in a measurement using a wet flow type image analyzer, at least two or more of S₁, S₂, S₄, and S₅ are 0.85 or more, and S₃ is 0.84 or less.

2. The spherical alumina powder according to claim 1,
wherein in a case where an average sphericity obtained from five values of S₁, S₂, S₃, S₄, and S₅ (excluding a value of 0) is defined as S_{AVE}, S_{AVE} is 0.80 or more.

3. The spherical alumina powder according to claim 1,
wherein a loose bulk density measured by the following procedure is 1.10 g/cm³ or more and 1.50 g/cm³ or less,
(Procedure)
the spherical alumina powder is allowed to free-fall from a height of 25 cm to be injected into a 100 cm³ cup for measurement in an injection amount of 5 to 10 g for 1 minute, and the injection is continued until the spherical alumina powder overflows from the cup to prepare a heaped cup;
next, after rubbing off the powder overflowing from an upper surface of the heaped cup without tapping, a mass (g) of the spherical alumina powder filled in the cup is measured to calculate the loose bulk density (g/cm³); and
on the other hand, after tapping the heaped cup in a vertical direction under a condition of 180 times (stroke length: 2 cm, 1 sec/time) and rubbing off the powder overflowing from the upper surface of the cup, a mass (g) of the spherical alumina powder filled in the cup is measured to calculate a tight bulk density (g/cm³).

4. The spherical alumina powder according to claim 3,
wherein in a case where the loose bulk density measured by the procedure is denoted as A and the tight bulk density measured by the procedure is denoted as P, a compression degree obtained based on ((P−A)/P)×100 is 35% or more and 55% or less.

5. The spherical alumina powder according to claim 1,
wherein in a volume frequency particle size distribution measured by a laser diffraction scattering method under wet conditions, in a case where a particle diameter corresponding to a cumulative value of 25% is defined as D₂₅ and a particle diameter corresponding to a cumulative value of 97% is defined as D₉₇, D₉₇/D₂₅ is 8.0 or more and 30.0 or less.

6. The spherical alumina powder according to claim 1,
wherein in a volume frequency particle size distribution measured by a laser diffraction scattering method under wet conditions, in a case where a particle diameter corresponding to a cumulative value of 50% is defined as D₅₀ and a particle diameter corresponding to a cumulative value of 97% is defined as D₉₇, D₉₇/D₅₀ is 5.0 or more and 20.0 or less.
